(19) United States
(12) Patent Application Publication
(10) Pub. No.: US 2007/0161116 A1
(43) Pub. Date: Jul. 12, 2007

(54) Differential analysis of cell surface proteins on closed membrane structures by labelling with dyes in the presence of an internal standard

(76) Inventor: Catherine Copse, Amersham, Buckinghamshire (GB)

Correspondence Address: GE HEALTHCARE BIO-SCIENCES CORP.;PATENT DEPARTMENT, 800 CENTENNIAL AVENUE, PISCATAWAY, NJ, 08855, US

(21) Appl. No.: 10/557,521

(22) PCT Filed: May 28, 2003
(86) PCT No.: PCT/GB03/02323

§ 371 Date: Sep. 11, 2006

(51) Int. Cl. G01N 21/76

(52) U.S. Cl. 436/172

(57) ABSTRACT

Disclosed are matched fluorescent reagents and a method for reproducibly labelling membrane components, such as those expressed on the cell surface, and subsequent differential analysis of the labelled components to detect differences between cell types and states. Furthermore, the present method utilises an internal standard in order to match protein patterns across gels thereby avoiding gel-to-gel variation. The method according to the invention is particularly useful, for example, for detecting low abundance membrane proteins, for detecting changes in receptors expressed in the cell membrane, for example on ligand binding, or in response to stimuli.

The present invention relates to a method for differential analysis of surface membrane components of samples containing closed membrane structures. The method relates more particularly to the use of luminescent dyes with cell permeability characteristics to target and label in vivo, intact cell populations so as to label and detect components that occur or are expressed in, or on, the cell membrane.

Cell membranes have important functions that are crucial to the life of the cell. All biological membranes are characterised by a common general structure, composed of lipid and protein molecules held together mainly by non-covalent interactions. Whilst membrane lipids form a permeability barrier, thereby defining the cell boundary, membrane proteins mediate specific cellular processes, such as biological signalling, transport of small molecules and cell adhesion. It is therefore important to an understanding of disease states to be able to identify and distinguish membrane components, particularly proteins and their derivatives, between different cell types and states.

2-Dimensional (2D) Difference Gel Electrophoresis (DIGE) uses matched, spectrally-resolved fluorescent dyes to label protein components of cells prior to 2-D electrophoretic separation (Minden, J. et al, Electrophoresis, (1997), 18, 2071). WO 96/33406 (Minden, J. and Waggoner, A. S.) describes a method whereby different cell samples are lysed and the total cellular proteins extracted. The different protein samples are then labelled with dyes that are matched for molecular mass and charge to give equivalent migration in 2-DE. The approach employs cyanine dyes having an N-hydroxysuccinimidyl (NHS) ester reactive group to label amines. The fluorescent pre-labelling of protein samples allows multiple samples to be run on the same gel, enabling quantitative differences between the samples to be easily identified by overlaying the fluorescent images. However, this method is not able to distinguish protein components that occur in the cell membrane, from other cellular proteins.

Labelling of intact cells to target and characterise cell surface proteins has been achieved through the use of biotin labelling reagents, enhanced chemiluminescence and by using fluorescent labelling reagents. For example, Meier, T. et al (Anal. Biochem., (1992), 204, 220 226) describe a procedure for the labelling and detection of immuno-precipitated cell surface molecules that combines biotin succinimide ester labelling of whole cells with enhanced chemiluminescence to detect nitrocellulose transferred biotinylated antigens after binding to a streptavidin-HRP complex. The biotin labelling approach however, requires blotting of the gel to transfer the proteins onto a solid membrane support. The detection of biotinylated proteins is usually performed using a streptavidin-enzyme conjugate with a substrate producing a detectable product. Biotinylated samples cannot be multiplexed for direct comparative studies, which decreases the ability to obtain accurate quantitative information.

Bös, C. et al (J. Bacteriol., (1998), 180(3), 605) describe the use of fluorescein maleimide to label exposed cysteine residues on cell surface proteins in E. coli and analysis by flow cytometry and SDS-PAGE to study conformation changes in FhuA membrane protein upon binding by ferrichrome.

WO 02/099077 (Proteologics Inc.) discloses a method for differential display of membrane surface proteins, wherein two or more samples to be analysed are each labelled with marking moieties selected so as to be distinguishable. After labelling, proteins from each sample may be mixed and subjected to further analysis together, for example by two-dimensional electrophoresis.

The present invention provides fluorescent reagents and describes a method for reproducibly labelling membrane components, such as those expressed on the cell surface, and subsequent analysis of the labelled components to detect differences between different cell types and states. Furthermore, the present method utilises an internal standard in order to match protein patterns across gels thereby avoiding gel-to-gel variation. The method according to the present invention is useful for example, for detecting low abundance membrane proteins, for detecting changes in receptors expressed in the cell membrane, for example on ligand binding, or in response to stimuli. The use of fluorescence labelling of cell surface proteins enables direct in-gel detection of labelled proteins and the use of migration matched dyes enables multiplexing for differential analysis. Using dyes with different membrane permeability characteristics enables targeting of different protein subsets of the cell, for example, membrane proteins and cytosolic proteins.

Accordingly, in a first aspect of the invention, there is provided a method of detecting differences between surface membrane components from at least two samples containing closed membrane structures, said method comprising:
i) contacting a separate aliquot of each sample with a dye chosen from a matched set of dyes wherein each dye in said matched set is capable of selectively labelling said membrane components and wherein each dye emits luminescent light having a property that is distinguishably different from the emitted luminescent light of the remaining dyes in said matched set;
ii) preparing extracts of dye-labelled components from each separate aliquot;
iii) separating the different dye-labelled components; and
iv) detecting differences in a luminescence property between the different dye-labelled components in said samples;
characterised in that said separating step iii) is performed in the presence of an internal standard comprising an extract of membrane components from a pooled mixture of aliquots of said at least two samples and wherein said pooled mixture of samples containing membrane structures is contacted with a different dye chosen from said matched set of dyes.

Suitably, each dye of the matched set of dyes is matched one with the other by virtue of its charge and molecular weight characteristics, whereby relative migration of a component labelled with any one of the said dyes is substantially the same as the relative migration of said component labelled with any other dye in the matched set of dyes.

According to the method of the invention, separate aliquots of each sample may be contacted with the same dye, or with a different dye chosen from the set of dyes. Thus, the dye-labelled components from one sample may or may not have identical luminescent properties when compared with the luminescent properties of dye-labelled components from any other sample.

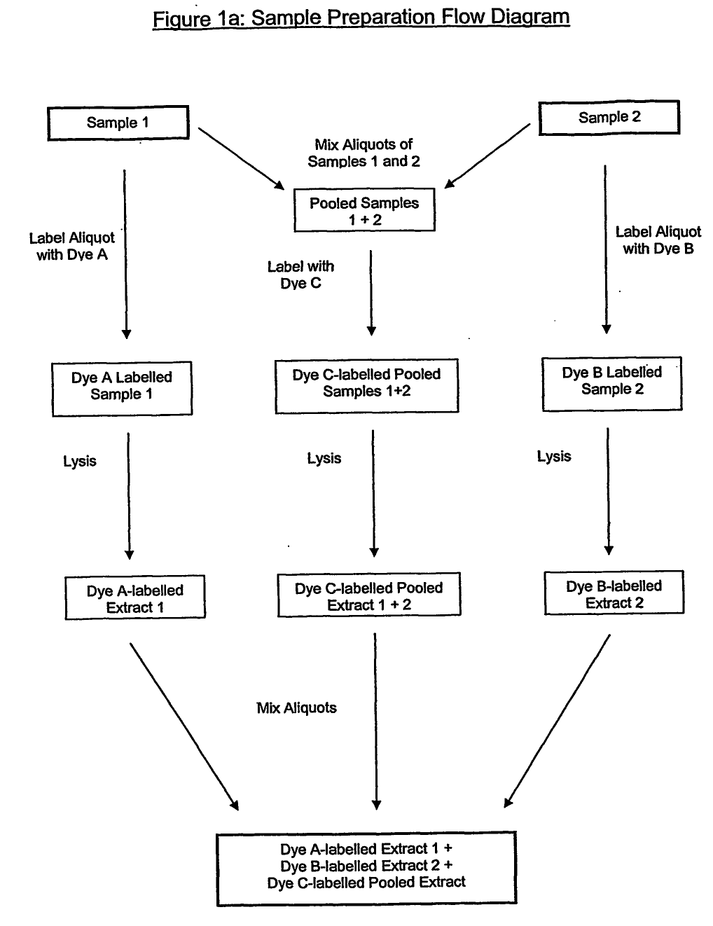

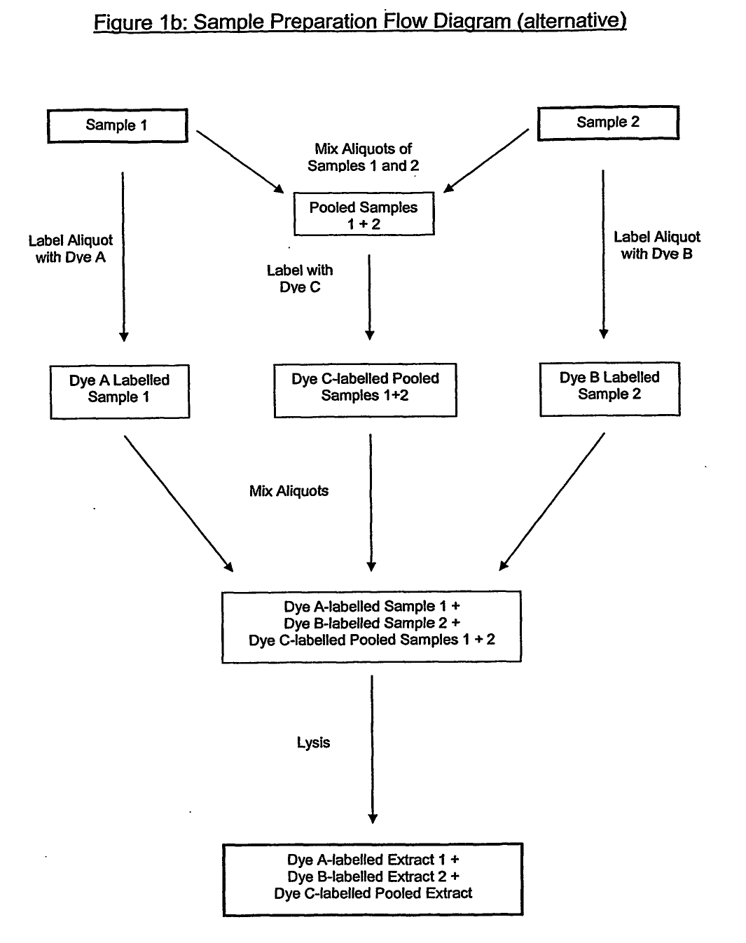

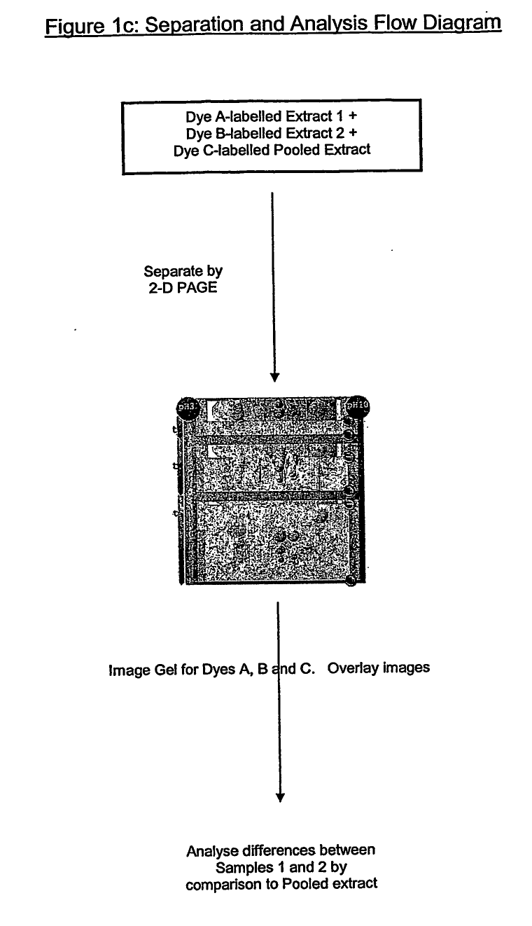

Thus, in a first embodiment according to step i) of the method, a separate aliquot of each of said samples is contacted with a different dye chosen from the matched set of dyes, so as to label the surface membrane components in each sample. The flow diagrams of FIG. 1 illustrate the sample preparation (1a, 1b), and the separation and analytical methods (1c) according to the first embodiment for two different samples. In one variant of the method, as shown in FIG. 1a, a lysis step is employed to obtain extracts of the dye-labelled components from each sample, and from the pooled mixture. As an alternative, as shown in FIG. 1b, each of the dye-labelled samples are mixed together with the labelled pooled sample, prior to lysis of the sample mixture, so as to obtain a mixture of dye-labelled extract, before separating and analysing the labelled components (FIG. 1c). The alternative procedure according to FIG. 1b has the advantage that the samples for analysis on the same gel will all undergo identical lysis conditions, which may avoid possible artefacts that may be introduced during sample preparation. In this embodiment, the method comprises before step iii), the step of mixing a portion of the extract of dye-labelled components from all samples with each other and with a portion of the extract of dye-labelled components from said pooled mixture before separating the components.

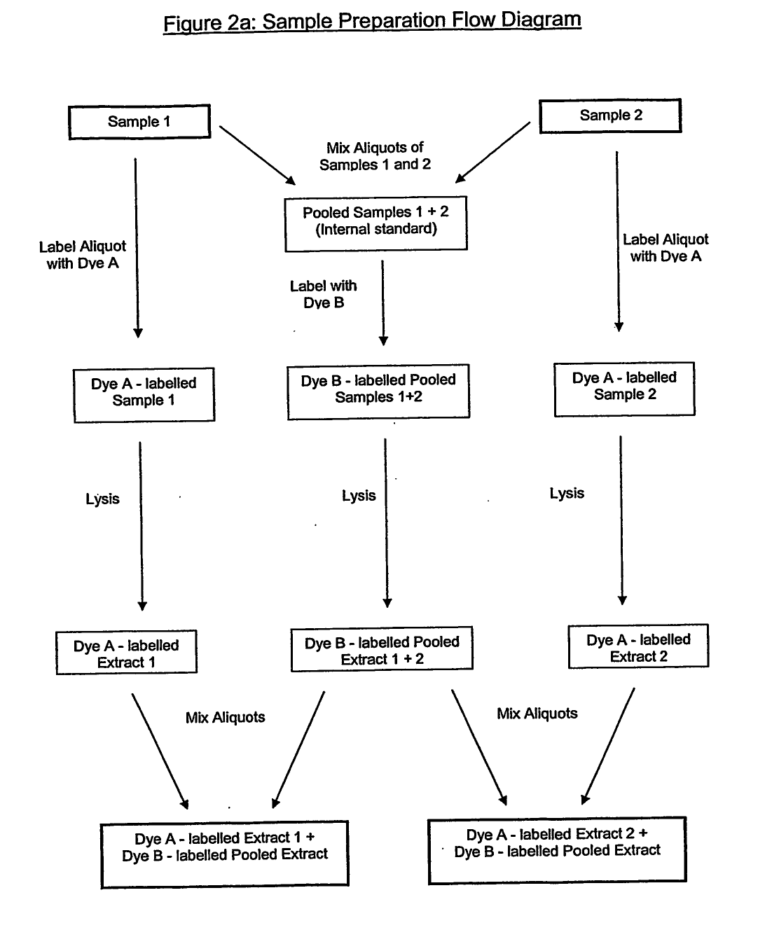

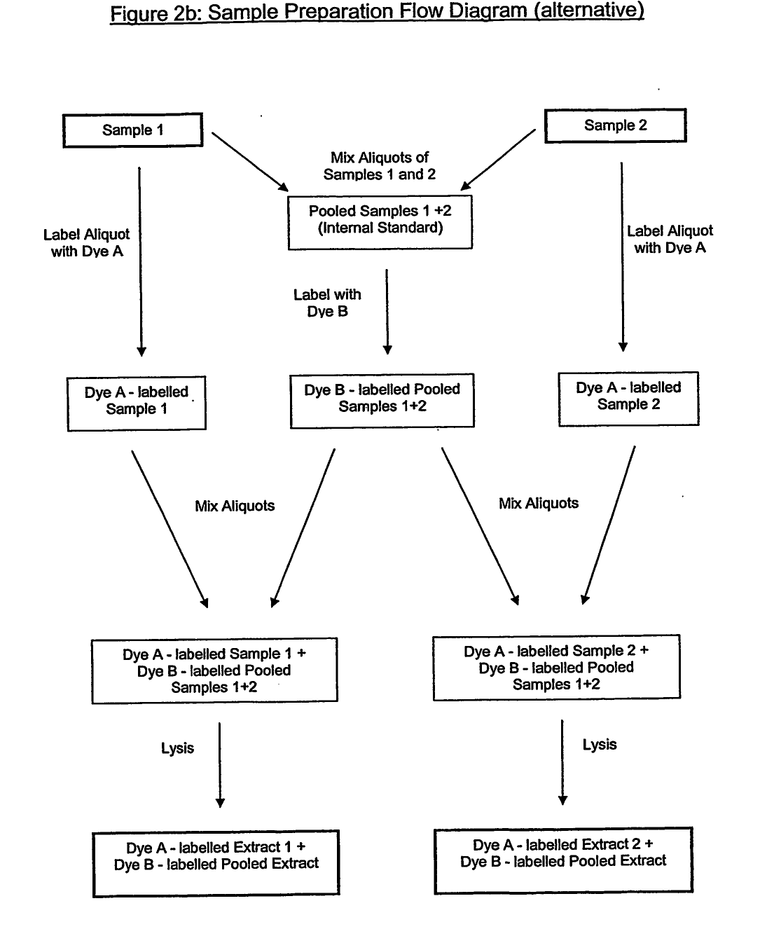

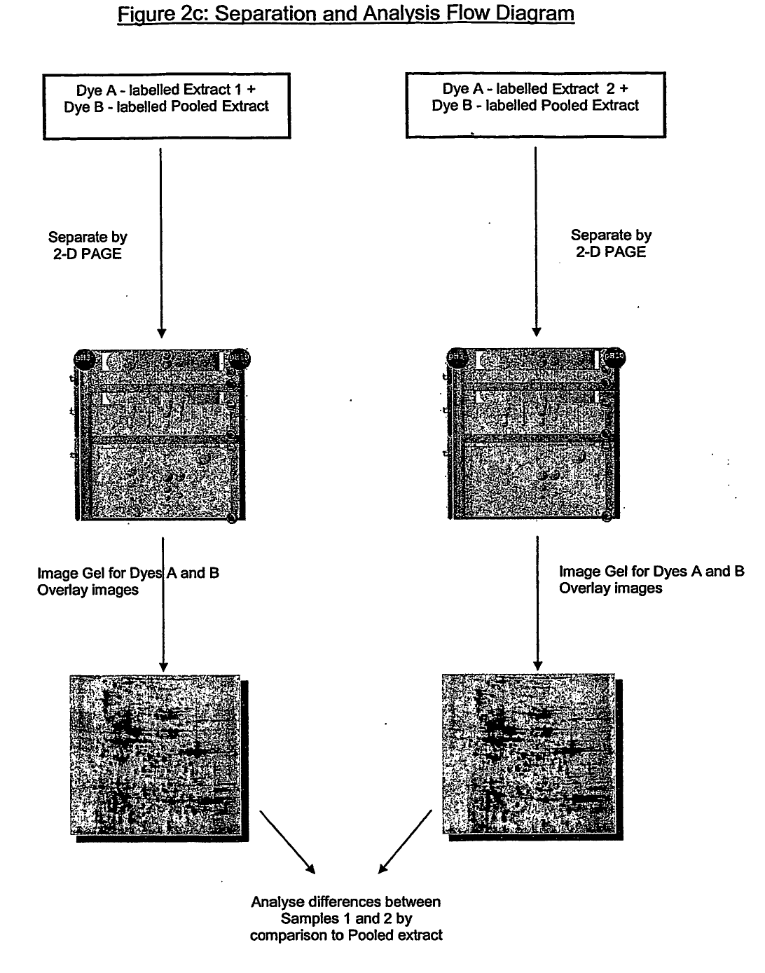

In a second and preferred embodiment, each separate aliquot of said samples is contacted with the same dye chosen from the matched set. The method according to the second embodiment is illustrated by means of the flow diagrams of FIG. 2 (2a, 2b and 2c) for two different samples. In this embodiment, a lysis step may be employed (as shown in FIG. 2a) to obtain extracts of the dye-labelled components from each sample, and from the pooled mixture, and then mixing the dye-labelled extracts so obtained together with the labelled pooled extract. Alternatively, (as shown in FIG. 2b), mixing of the dye labelled samples and the pooled mixture may take place prior to the lysis step. In this embodiment, the method comprises before step iii), the step of providing a portion of the extract of the dye-labelled components from said pooled extract mixed with a portion of the extract of dye-labelled components from each separate sample before separating the components.

Suitably, the internal standard comprises an extract of components from a pooled mixture comprising approximately equal aliquots of each said sample of membrane structures. The pooled-mixture is contacted with a different dye chosen from the matched set of dyes, that is, a dye that possesses different luminescent properties from the dye (or dyes) chosen to label each of the separate samples. The dye chosen to label the pooled mixture will possess the same mobility and charge characteristics as all of the remaining dyes in the matched set, and the dye will be capable of selectively labelling the membrane components. However, the dye-labelled components from the pooled extract will possess a luminescent property that is different from the luminescent properties of the dye-labelled components from each separate sample extract.

Thus, the present invention relates to matched fluorescent dyes and to a method for labelling and detecting differences between surface membrane components of membrane structures from different samples. Suitably, the membranes may be constituents of whole cells. Alternatively, the membranes may form part of internal cellular structures such as cell organelles, mitochondria and the cell nucleus. In particular, the invention relates to a method for the differential analysis of protein components, such as membrane proteins or fragments thereof. Alternatively, the method may be used for analysing differences in a carbohydrate component between cell samples.

According to the invention, reactive fluorescent dyes with specific cell permeability characteristics are used to target and label proteins expressed in different parts of the cell membrane for differential analysis of protein expression and protein composition. Proteins as defined herein are taken to include post-translationally modified proteins and protein fragments, e.g. peptides. Examples of post-translationally modified proteins include phosphorylated proteins (phospho-proteins) and glycoproteins. The method allows a comparison of membrane proteins of intact cell populations, or biological tissues, in different samples of interest (for example, control tissue versus diseased tissue; control tissue or cells versus drug treated tissue or cells).

In a preferred embodiment, the dyes are used as a matched pair to label membrane proteins. With reference to the flow diagrams of FIG. 2a and 2b according to the present method, separate aliquots of each cell or tissue sample are incubated with a first dye chosen from a matched pair of dyes. Each of the dyes in the matched pair is capable of selectively labelling the membrane protein components, and each dye has characteristics whereby relative migration in a separation medium, of a protein labelled with either one of the dyes in the matched pair of dyes is the same as the relative migration in the separation medium of that component labelled with the other dye. Furthermore, each dye emits luminescent light having a property that is distinguishably different from the emitted luminescent light of the other dye.

Multiplexing of samples in differential protein analysis has greatly improved the detection of protein levels between different samples. However, variations in spot intensities, due to experimental factors such as protein loss during sample entry into the gel strip, or gel-to-gel variation, may be a major source of error in experimental design. Thus, to avoid incorrect biological conclusions resulting from the interpretation of gels, suitably, a standard sample (the internal standard) is included on each gel and is run with each separation. The use of an internal standard for quantifying total protein differences utilising the DIGE methodology has been described previously, see Alban, A. et al, Proteomics, (2003), 3, 36-44. Each protein spot in a sample can be compared to its representative within the internal standard to generate a ratio of relative expression. Quantitative comparisons of samples between gels are made, based on the relative change of sample to its in-gel internal standard. This process effectively removes the system (gel-to-gel) variation, enabling accurate quantitation of induced biological change between samples. The need to run gel replicates is also overcome, thereby reducing the number of gels required per experiment. Using an internal standard matching between gels is also more straightforward. Since the internal standard image is common between all gels in an experiment, matching can be performed between internal standard images. Conventional 2-D electrophoresis requires matching between different samples on different gels, which introduces differences in spot patterns due to sample-to-sample and gel-to-gel variation. Matching between internal standards allows matching between identical samples; thus differences in spot patterns are due only to electrophoretic differences.

In the preferred embodiment according to the invention and with reference to FIGS. 2a and 2b, the pool of all cell samples is labelled with the second dye of the matched pair of dyes. Every surface membrane component from all of the samples to be studied will be represented in the internal standard and each component within a sample can be compared with itself in the internal standard, thereby allowing accurate quantitation of differences in cell surface components between cell samples. The use of two dyes ensures that no labelling artefacts are introduced between samples, as each separate sample is labelled with the same dye and the internal standard is always labelled with the second dye. The use of two dyes according to the preferred method, therefore provides simpler matching of dye design characteristics to ensure equivalent migration of labelled components.

The present invention provides reagents suitable for use in the preferred method according to the invention. Preferably, a pair of fluorescent dyes is employed, the dyes being matched one with the other by virtue of their charge and molecular weight characteristics. Thus, the dyes are preferably of approximately equal molecular weight, but need not be. Furthermore, the dyes are matched by charge, such that differentially labelled proteins migrate to same position following separation by electrophoresis in one or two dimensions. Dyes that retain the native charge of the protein are particularly preferred, since there is no pl shift resulting from proteins labelled with such dyes. When lysine is target group of the protein, the dye should possess a net charge of +1; for dyes that target cysteine residues in a protein, the net charge should be neutral.

Suitably, the dyes for use according to the method of the invention are designed with permeability characteristics to target specific regions of the cell, such as externally exposed proteins. Exemplary specific labelling reagents are substantially membrane impermeable and therefore are capable of selectively labelling surface membrane components, preferably, target membrane proteins that have exposed regions expressed on the cell surface. Such reagents are selective for surface proteins by being membrane impermeable, thereby avoiding labelling of internal proteins. Reagents suitable for labelling cell surface proteins for subsequent detection and analysis are those that ideally possess the following properties:
a) The reagent should not penetrate the cell membrane. Thus, in general, the dye should possess an overall charge which increases the hydrophilicity of the dye and prevents the dye molecule from passing through the hydrophobic lipid core of the cell membrane. Thus, the dyes may contain one or more substituents covalently attached to the dye chromophore for conferring a hydrophilic characteristic to the dye. Suitable substituents include sulphonate, sulphonic acid and quaternary ammonium, that may be attached directly to the dye structure, or, alternatively via a linker group, such as a C₁ to C₆ alkyl chain. One or more sulphonate or sulphonic acid groups attached directly to the dye structure are particularly preferred.
b) The reagent should react under physiological conditions to maintain the native state of the surface proteins. Preferably, each of the dyes in the matched set is capable of selectively reacting with and thereby labelling the membrane components by covalent attachment. In a preferred embodiment, the dyes should react specifically with proteins having a complementary target functional group, thereby forming a stable bond with the protein. This is important where downstream analysis requires the use of denaturing conditions (such as in electrophoresis).
c) Each of the dyes in the matched set should be easily detectable and resolvable by the detection means. Thus, suitably, each dye emits luminescent light having a property that is distinguishably different from the emitted luminescent light of the remaining dyes in the set. Preferably, each of the dyes is distinguishably one from the other by virtue of its fluorescence wavelength and/or its fluorescence lifetime. Thus, the luminescent property may be the emission wavelength of the dye, each dye being characterised by its different luminescence wavelength from any other dye in the matched set. Alternatively, the luminescent property of the dyes may be their luminescent lifetimes, each dye in the set being characterised by a different luminescent lifetime.

Dyes that possess suitable characteristics for use in the present invention may be selected from the well known classes of fluorescent dyes including fluoresceins, rhodamines, cyanine dyes, acridone dyes and quinacridone dyes.

A preferred class of dye for use in the present invention are the cyanine dyes. The cyanine dyes are characterised by strong spectral absorption bands with the absorption being tuneable over a large spectral range by synthetic design. Particularly preferred dyes are selected from cyanine dyes having the structure (1). 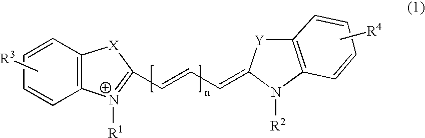
wherein:
n is an integer from 1 to 3;
X and Y are the same or different and are selected from: >C(CH₃)₂, O and S;
one of groups R¹ and R² is the group -E-F where E is a spacer group having a chain from 1-20 linked atoms selected from linear or branched C₁₋₂₀ alkyl chains, which may optionally contain one or more ether linkages, one or more amide linkages, and one or more unsaturated groups, and F is a target bonding group capable of reacting with a complementary group on the component to be labelled;
remaining group R¹ or R² is selected from: C₁-C₆ alkyl, or the group —(CH₂)ₘ—W wherein W is selected from: 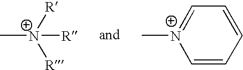
wherein R′, R″ and R′″ are selected from C₁-C₄ alkyl and m is an integer from 1 to 10;
at least one of groups R³ and R⁴ is a sulphonate or a sulphonic acid group;
and when one of said R³ and R⁴ groups is not a sulphonate or a sulphonic acid group, said remaining group R³ or R⁴ is a hydrogen.

Preferably, the cyanine dyes according to formula (1) are a matched pair of dyes in which n is different for each dye and is 1 or 2; and X and Y are both >C(CH₃)₂.

Alternative dyes for use in the present invention may be selected from the acridone dyes having the structure (2): 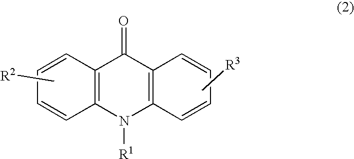
wherein:
one of groups R¹, R² and R³ is the group E-F where E is a spacer group having a chain from 1-20 linked atoms selected from linear or branched C₁₋₂₀ alkyl chains, which may optionally contain one or more ether linkages, one or more amide linkages, and one or more unsaturated groups, and F is a target bonding group capable of reacting with a complementary group on the component to be labelled;
when either of groups R² or R³ is not said group -E-F, they are independently selected from hydrogen, halogen, amide, hydroxyl, amino, mono- or di-C₁-C₄ alkyl-substituted amino, sulphydryl, carboxyl, C₁-C₆ alkoxy, C₁-C₆ alkyl, sulphonate, sulphonic acid, quaternary ammonium and the group —(CH₂—)ₙ-Z; and,
when group R¹ is not said group -E-F, it is selected from hydrogen, C₁-C₆ alkyl, the group —(CH₂)ₖ-Z, wherein Z is selected from sulphonate, sulphonic acid, quaternary ammonium and carboxyl; and k is an integer from 1 to 6.

Suitably, the target bonding group F in the compounds of formula (1) or (2) is a reactive or a functional group. A reactive group can react under suitable conditions with a functional group of a component to be labelled (as shown in Table 1); whereas a functional group can react under suitable conditions with a reactive group of the component, such that the component becomes labelled with the compound.

TABLE 1
Possible Reactive Groups and Functional
Groups Reactive Therewith

| Reactive Groups | Functional Groups |
|---|---|
| succinimidyl esters | primary amino, secondary amino |
| isothiocyanates | amino groups |
| haloacetamides, maleimides | sulphydryl, imidazole, hydroxyl, amine |
| acid halides | amino groups |
| anhydrides | primary amino, secondary amino, |
| | hydroxyl |
| hydrazides, | aldehydes, ketones |

Preferably, the target bonding group F is a reactive group reactive with hydroxyl, amino, sulphydryl and aldehyde groups. More preferably, the reactive group is selected from succinimidyl ester, sulpho-succinimidyl ester, isothiocyanate, maleimide, haloacetamide and hydrazide.

Suitably, in the compounds of formulae (1) and (2), spacer group E has from 1 to 20 linked atoms, preferably, from 6 to 15 atoms.

Preferably, E is the —{(CHR^{a})ₚ-Q-(CHR^{a})ᵣ}ₛ— where Q is selected from: —CHR^{a}—, —NR^{a}—, —O—, —(CH═CH)—, and —CO—NH—, R^{a} is hydrogen or C₁-C₄ alkyl, p is 0-5, r is 1-5 and s is 1 or 2. Particularity preferred Q is selected from: —CHR^{a}—, —O— and —CO—NH—, where R^{a} is hereinbefore defined.

Preferred cyanine dye pairs for labelling lysine residues on cell surface proteins are the mono-sulphonated NHS esters of Cy™3 and Cy5, Compounds I and II.

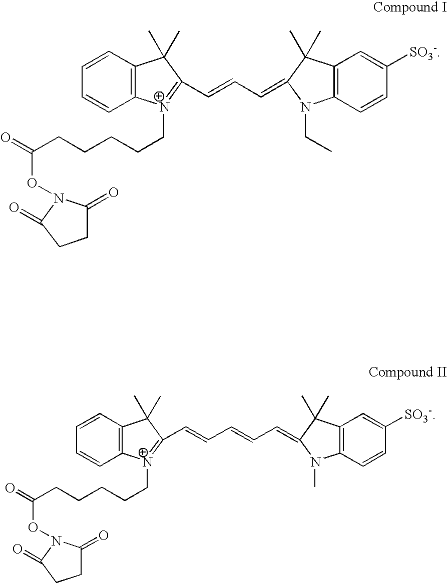

With lysine as the target protein functional group, labelling with a cyanine dye results in the loss of a positive charge. Therefore, it is preferred to compensate for this loss of charged lysine residue by using a positively charged dye in order to maintain the native pi of the protein. In this way, the migration position of a dye-labelled protein is unchanged compared with the unlabelled protein. Additional positive charge may be achieved using positively charged linkers attached to the dye, for example by means of covalent attachment to the indole nitrogen atom.

Suitable examples of positively charged cyanine dyes are the mono-sulphonated cyanine dye NHS esters having a quaternary ammonium linker, Compounds, III and IV.

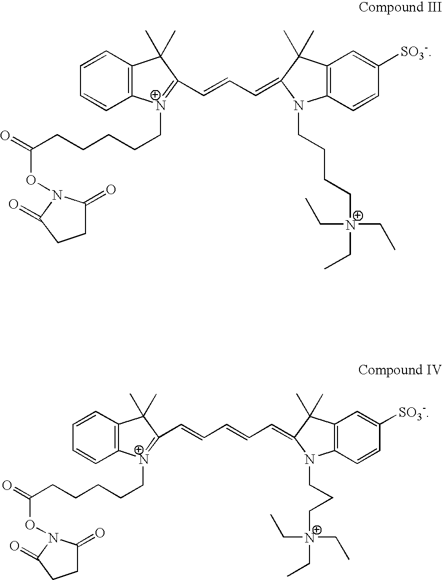

Further examples are mono-sulphonated cyanine dye NHS esters having a pyridinium linker, Compounds V. and VI.

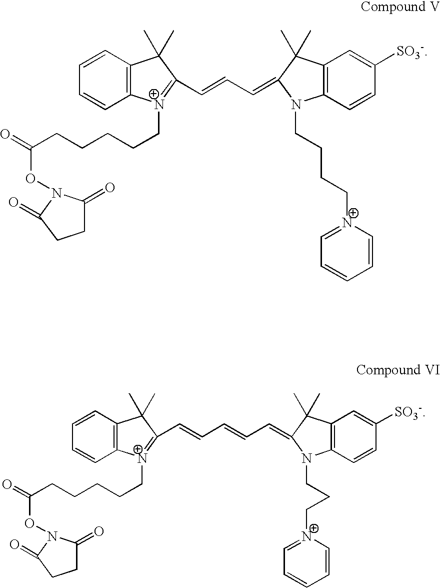

Suitable cyanine dye pairs for labelling cysteine residues on cell surface proteins are the mono-sulphonated maleimido derivatives of Cy3 and Cy5, Compounds VlI and VIII.

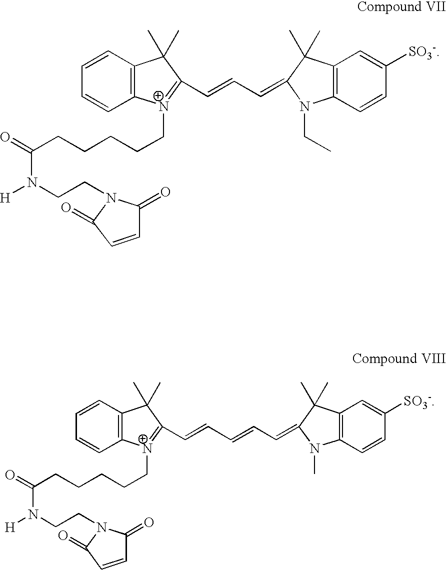

Alternatively, dyes may be employed that can target subsets of proteins, such as post-translationally modified proteins, for example the glycoproteins. It is possible to label the terminal carbohydrate groups of glycoproteins by first oxidising the vicinial hydroxyl groups of terminal sugars to aldehyde groups, followed by reaction with the dye bearing a hydrazide reactive group (see Wilchek, M. and Bayer, E. A., Methods in Enzymology, Volume 138, 429-442 (1987). Suitable cyanine dye pairs for labelling carbohydrate groups on cell surface glycoproteins are the monosulphonated hydrazide derivatives of Cy3 and Cy5, Compounds IX and X. Alternative reactive groups useful for labelling carbohydrate groups are semicarbazides or amino derivatives. In order to maintain the overall charge on the glycoprotein, suitable dyes should bear an overall neutral charge. An overall net neutral charge may be obtained by the use of a suitably charged linker, such as the group W as hereinbefore defined.

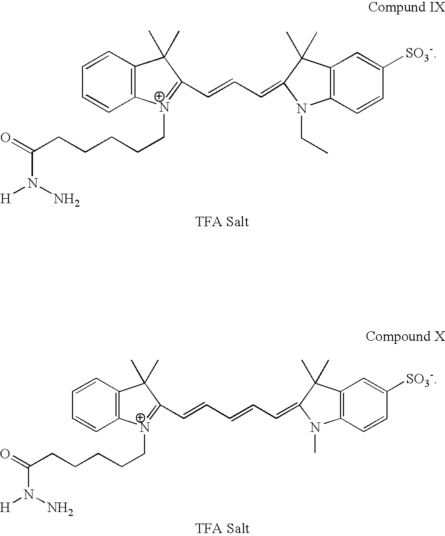

More specifically, the method would involve: firstly treating intact cells with an oxidising agent such as sodium metaperiodate for a short period to oxidise vicinial diols to aldehyde groups, prior to labelling the cell surface with a fluorescent dye selected from the matched pair of dyes, for example compounds IX and X. Alternatively, it is possible to label cell surface glycoproteins by treatment of the cell sample with galactose oxidase to generate an aldehyde group on a terminal galactose, followed by reaction with a suitable fluorescent dye.

The method according to the present invention may be used with a variety of cell types, including all normal and transformed cells derived from any recognised source with respect to species (e.g. human, rodent, simian), tissue source (e.g. brain, liver, lung, heart, kidney skin, muscle) and cell type (e.g. epithelial, endothelial). The invention may also be used to compare cell surface components in samples from plants for example, using cultured plant cells. There are established protocols available for the culture of diverse cell types. (See for example, Freshney, R. I., Culture of Animal Cells: A Manual of Basic Technique, 2^{nd} Edition, Alan R.Liss Inc. 1987). In addition, samples for use in the method of the invention may be derived from cells which have been transfected with recombinant genes and thereafter cultured; or cells which have been subjected to an external stimulus (such as heat shock or drug treatment).

If it is desired to target membrane proteins in cell organelles (e.g. nucleus, mitochondria) a pre-fractionation step may be introduced into the method, prior to labelling-the membrane structures. In such cases, membrane structures may be enriched by means of any of the well-known methods. For example, differential centrifugation, density gradient centrifugation (for example using a sucrose gradient), continuous flow electrophoresis, or aqueous two-phase partitioning.

Methods for labelling surface membrane components with a fluorescent dye will be well known and generally comprise contacting the membrane with the selected fluorescent labelling reagent for a sufficient incubation period to allow binding of the reagent and the formation of stable links between the dye and the surface membrane components.

The dye-labelled membrane components may be isolated from intact membranes to form extracts using a variety of well known methods and extraction reagents. Typically, cells from the tissue/culture are disrupted, for example by homogenisation, sonication, cell lysis, and the protein extracted and solubilised in the presence of reagents including denaturing reagents, such as urea, thiourea, detergents such as SDS, CHAPS, Triton X-100, NP-40, reducing agents, such as dithiothreitol (DTT), mercaptoethanol, and buffer such as Tris, HEPES. A number of factors should be considered when selecting the buffer and the pH for extraction, including the degree of buffering capacity required, the influence of temperature and ionic strength on pH, interaction with metal ions and compatibility with subsequent purification procedures. Typically, extraction may be performed in the range pH 5-9. Protease inhibitors, such as phenylmethane-sulphonyl fluoride (PMSF), ethylenediaminetetraacetic acid (EDTA), leupeptin, aprotinin, may also be added to minimise degradation by endogenous proteases. In order to enhance the sensitivity of detection, dye labelled membrane components at low abundance may be physically enriched in the sample prior to analysis using a variety of well-known methods, for example by the use of solid phase antibodies that bind to the dyes.

The dye labelled components from each cell sample are separated by a separation method capable of resolving the sample into discrete components. Suitably, a portion of the extracts of the dye-labelled components from the pooled mixture of all samples is run as an internal standard. Preferably, a portion of the dye-labelled extract from the pooled mixture is added to a portion of each individual extract of labelled membrane components prior to separation. Techniques for separating cellular components such as carbohydrates, proteins and their derivatives are well known. The separation step is typically based on physical properties of the labelled components (e.g. charge and molecular weight) and may be by means of an electrophoretic method or a chromatographic method. For example, peptides and proteins may be separated by one-dimensional electrophoresis, two-dimensional electrophoresis, capillary zone electrophoresis, capillary gel electrophoresis or isoelectric focussing. If a chromatographic method is employed, this may be by means of affinity chromatography, size exclusion chromatography, reverse phase chromatography, hydrophobic interaction chromatography, or ion exchange chromatography. A preferred analytical method for separating the labelled components, especially labelled cell surface proteins is 2-D gel electrophoresis.

The separated proteins are detected and/or quantitated by optical means, suitably an imaging instrument, such as a CCD camera, fluorescence scanner or confocal imager. By analysing the fluorescent signals emitted from different labelled components, differences in proteins present between samples may be determined. Comparison of the relative fluorescent signals between proteins from different samples may be used to quantify changes in the abundance of proteins as a result of induced biological change, for example, as a result of disease or drug treatment. Analysis of gel images is typically performed using software designed specifically for 2-DE analysis. For example, DeCyder™ (Amersham Biosciences) is a fully automated image analysis software for spot detection, background subtraction, normalisation, quantitation, positional matching and differential protein expression analysis of multiplexed images. This enables co-detection of differently labelled samples within the same gel and inter-gel matching of internal standard samples across all gels within an experiment Comparison with the internal standard then allows protein abundance ratios between samples to be determined and statistical tests applied to determine the significance of the data.

The identity of the proteins in the sample are typically obtained by isolating the protein of interest after the separation step, digesting the protein with trypsin and performing peptide mass fingerprinting by MALDI-MS. The identity of individual protein components may also be determined using MS/MS peptide sequencing. In order to unambiguously identify labelled proteins (and thus cell surface components), dye labelled components may be enriched, or purified from unlabelled components, prior to separation and/or MS analysis using a variety of well known methods, for example by the use of solid phase antibodies that bind to the dyes.

The present invention may also be used to target receptors present or expressed on the cell surface, such as those involved in cell signalling (e.g. hormone and growth factor receptors, G protein-coupled receptors), transporter proteins (e.g. sugar transport), ion channels (e.g. Na—K ATPase, H-ATPase), energy transducers (e.g. ATP synthetase), enzymes, antigen receptors, ligand binding (e.g. insulin receptor), and those having links to extracellular proteins such as cytoskeleton (e.g. integrins). The method may be used to directly compare the effect of different treatments, such as different cell stimuli, or the effect of different environmental effects on the membrane components, changes in abundance, cellular location, or conformation of proteins (e.g. by comparing free thiols or other functional groups) and post-translational modification of proteins (particularly glycosylation).

The present invention also provides a matched pair of dyes wherein each dye is capable of selectively labelling cell surface components. Furthermore, each dye emits luminescent light having a property that is distinguishably different one from the other. Thus in a second aspect there is provided a matched pair of dyes wherein each said dye is selected from cyanine dyes having the structure (1): 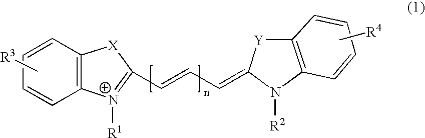
wherein:
n is an integer from 1 to 3;
X and Y are the same or different and are selected from: >C(CH₃)₂, O and S; one of groups R¹ and R² is the group -E-F where E is a spacer group having a chain from 1-20 linked atoms selected from linear or branched C₁₋₂₀ alkyl chains, which may optionally contain one or more ether linkages, one or more amide linkages, and one or more unsaturated groups, and F is a target bonding group capable of reacting with a complementary group on the component to be labelled;
remaining group R¹ or R² is selected from: C₁-C₆ alkyl, or the group —(CH₂)ₘ—W wherein W is selected from: 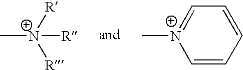
wherein R′, R″ and R′″ are selected from C₁-C₄ alkyl and m is an integer from 1 to 10;
at least one of groups R³ and R⁴ is a sulphonate or a sulphonic acid group;
and when one of said R³ and R⁴ groups is not a sulphonate or a sulphonic acid group, said remaining group R³ or R⁴ is a hydrogen.

Preferably, each of said dyes is matched one with the other by virtue of its charge and molecular weight characteristics whereby relative migration in a separation medium of a component labelled with one of said dyes is the same as the relative migration in said separation medium of the component labelled with the other dye

Preferably, n is different for each dye and is 1 or 2; and X and Y are both >C(CH₃)₂.

Suitably, each dye has a target bonding group reactive with hydroxyl, amino, sulphydryl and aldehyde groups. Preferably, the target bonding group is a reactive group selected from succinimidyl ester, sulpho-succinimidyl ester, isothiocyanate, maleimide, haloacetamide and hydrazide.

In one embodiment, one of groups R¹ and R² is the group -E-F as hereinbefore defined and remaining group R¹ or R² is selected from: C₁-C₆ alkyl. In another embodiment, remaining group R¹ or R² is the group —(CH₂)ₘ—W wherein W is selected from: 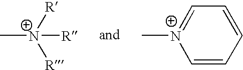
wherein R′, R″ and R′″ are selected from C₁-C₄ alkyl and m is an integer from 1 to 10;

The present invention may also be used to target receptors present or expressed on the cell surface, such as those involved in cell signalling (e.g. hormone and growth factor receptors, G protein-coupled receptors), transporter proteins (e.g. sugar transport), ion channels (e.g. Na—K ATPase, H-ATPase), energy transducers (e.g. ATP synthetase), enzymes, antigen receptors, ligand binding (e.g. insulin receptor), and those having links to extracellular proteins such as cytoskeleton. (e.g. integrins). The method may be used to directly compare the effect of different treatments, such as different cell stimuli, or the effect of different environmental effects on the membrane components, changes in abundance, cellular location, or conformation of proteins (e.g. by comparing free thiols or other functional groups) and post-translational modification of proteins (particularly glycosylation).

The invention is further illustrated by reference to the following examples and figures which are presented herein for illustrative purposes only and should not be construed as limiting the scope of the present invention as defined by the appended claims.

FIG. 1(a, b and c) are flow diagrams which illustrate two alternative sample preparation procedures (1a and 1b), and the separation and analysis protocol (1c) of one embodiment of the method according to the invention, using three labelling dyes.

FIG. 2(a, b and c) are corresponding flow diagrams showing the experimental design of a preferred embodiment of the method according to the invention utilising a matched pair of dyes.

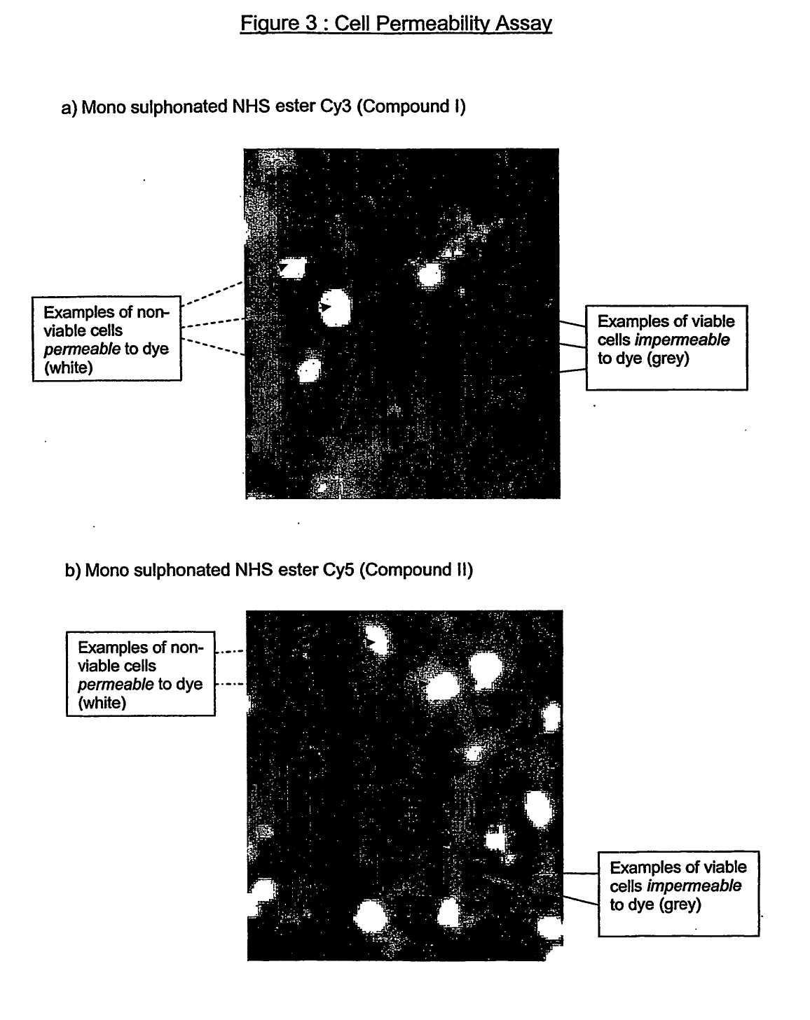

FIG. 3 is an image from a cell culture permeability assay. This shows that viable U937 cells (grey coloured cells) are impermeable to the mono-sulphonated NHS esters of (a) a Cy3 (Compound I) or (b) Cy5 (Compound (II) in PBS. A separate live/dead viability stain was used to show that the cells showing high dye uptake (white coloured cells) are the non-viable cells in the population.

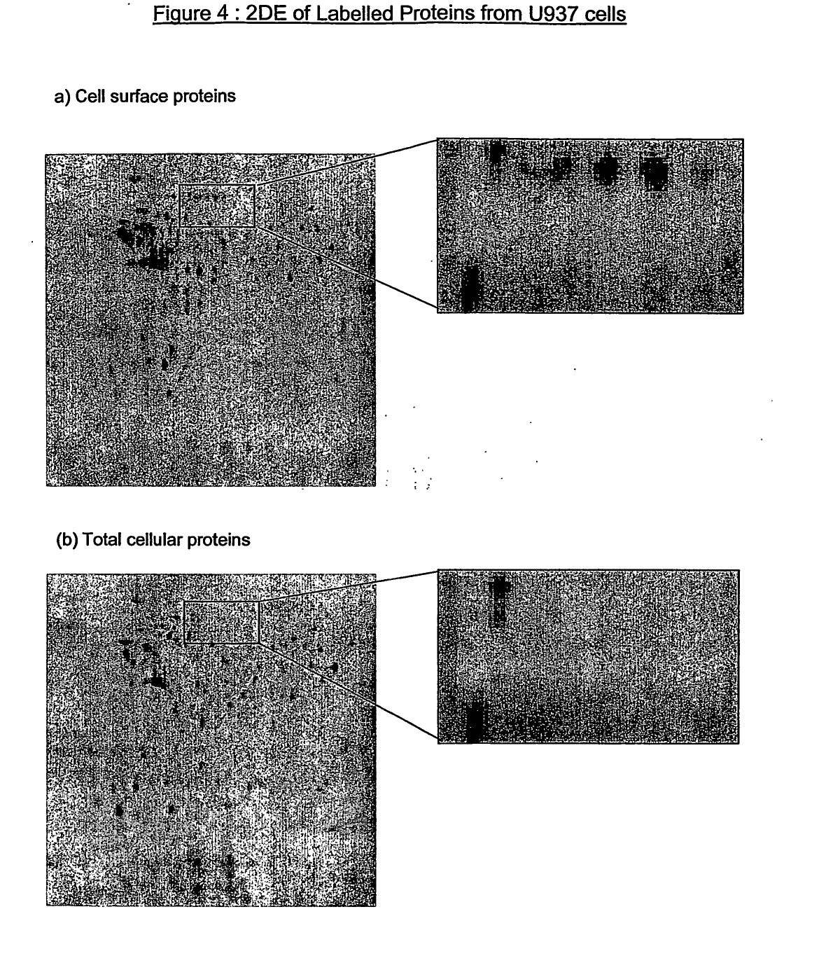

FIG. 4 shows images from 2-D electrophoresis gels separating protein extracted from U937 cells: (a) Cell surface proteins were labelled on intact cells using Cy3 mono-sulphonated NHS ester (Compound I). (b) Total cellular protein was labelled after cell lysis and protein extraction with Cy5 mono-sulphonated NHS ester (Compound II). From each figure, a region has been selected and magnified to highlight proteins present at the cell surface.

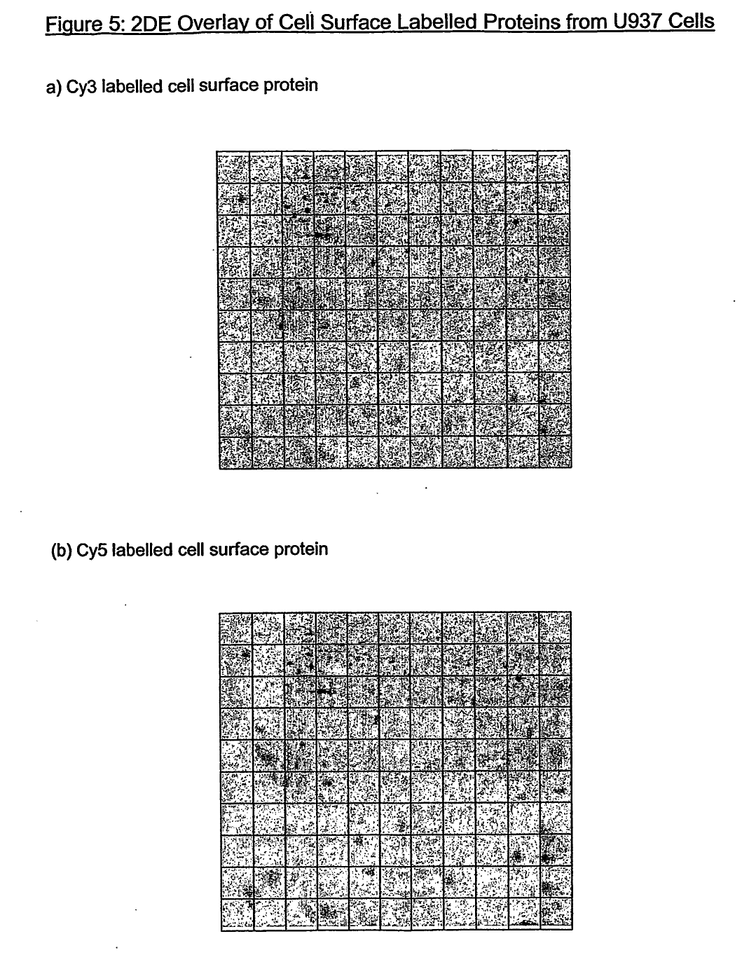

FIG. 5 shows images from 2-D electrophoresis gels of cell surface proteins labelled on intact U937 cells using (a) Cy3 mono-sulphonated NHS ester (Compound I) or (b) Cy5 mono-sulphonated NHS ester (Compound II). Proteins were extracted, mixed and separated on a single gel, and the two dyes co-detected. The grid-lines positioned over the same region of each image show the overlay and co-migration of proteins labelled with each dye.

### EXAMPLES

### Example 1

### Synthesis of Dyes

### i) General Experimental Procedures

1H NMR (δ_{H}) spectra were recorded on a Jeol JNM-LA300 FT NMR spectrometer. Chemical shifts are reported in δ (ppm). Samples were prepared as solutions in a suitable deuterated solvent such as d₄-methanol. UV/VIS spectroscopy was conducted using the Unicam UV3 UV/VIS spectrometer. Trimethoxypropene was purchased from Karl Industries Inc., Ohio, USA. All other chemicals were purchased from Sigma-Aldrich Company Limited, Dorset, England.

### ii) Potassium 2,3,3-trimethylindolenine-5-sulphonic acid

Hydrazinobenzenesulphonic acid (20.0 g) was dissolved in acetic acid (60 ml) and 3-methyl-2-butanone (26.0 g) added then heated at reflux for 3 hours. The desired compound was precipitated by cooling in the fridge with scratching and the off white slurry was diluted with propan-2-ol and filtered (71%).

The 2,3,3-trimethyl-5-sulphonyl-indolenine (16.45 g) was dissolved in methanol (160 ml) with heating and a saturated solution of KOH in propan-2-ol (100 ml) was added. The solution changed to a yellow colour and a solid formed. The solution was cooled and the solid was filtered to form an off-white solid (15.9 g, 98%). δ_{H} (300 MHz, CD₃OD) 7.84 (m, 2H), 7.46 (d, 1H), 3.30 (s, 3H) and 1.35 (s, 6H).

### iii) 1,2,3,3-Tetramethyl-5-sulphonyl-indolium iodide

Potassium 2,3,3-trimethylindolenine-5-sulphonic acid (1.0 g, 3.61 mmol) and iodomethane (0.25 ml, 3.97 mmol) were mixed with dichlorobenzene (10 ml) under a nitrogen atmosphere. The solution was heated at 100° C. using a sand bath for 4 hours. A solid had begun to form but analysis by tic (30% MeOH/70% DCM) showed product formation was not complete so an additional equivalent of iodomethane was added and the reaction heated for an additional 2 hours before cooling to room temperature. The solid was collected by filtration, washed with dichlorobenzene, diethyl ether then dried in vacuo to afford a purple solid (0.89 g, 98%). δ_{H} (300 MHz, CD₃OD) 8.06 (m, 1H), 7.94 (dd, 1H), 7.84 (m, 1H), 4.02 (s, 3H) and 1.61 (s, 6H).

### iv) 1-Ethyl-2,3,3-trimethyl-5-sulphonyl-indolium iodide

Potassium 2,3,3trimethylindolenine-5sulphonic acid (10.0 g, 41.97 mmol) and iodoethane (4.0 ml, 50.35 mmol) were mixed with dichlorobenzene (40 ml) under a nitrogen atmosphere. The solution was heated at 120° C. using a sand bath for 16 hours producing a purple solid. The solid was collected by filtration then washed with dichlorobenzene, chloroform and ether to produce pale pink solid, (10.2 g, 91%). δ_{H} (300 MHz, CD₃OD) 7.98 (m, 3H), 4.55 (q, 2H), 1.56 (s, 6H) and 1.48 (t, 3H).

### v) 1-(5-Carboxypentyl)-2,3,3-trimethyl-5-sulphonyl-indolium iodide

2,3,3-Trimethylindolenine (6.4 g, 40 mmol) was dissolved in dichlorobenzene (25 ml) and stirred until the solution was homogenous. To this was added 6-bromohexanoic acid (15.6 g, 80 mmol) and the reaction heated to 110° C. in a sand bath for 6.5 hours. The reaction was allowed to cool to room temperature where the sides of the flask were scratched then the flask was placed in the fridge for 1 hour. After this time, a beige solid had formed in the purple solution so the solid was collected by filtration then washed with dichlorobenzene and ether to afford a beige solid (7.42 g, 52%). δ_{H} (300 MHz, CD₃OD) 7.91 (m, 1H), 7.78 (m, 1H), 7.62 (m, 2H), 4.52 (t, 2H), 2.38 (t, 2H), 2.04 (p, 2H), 1.88-2.45 (m, 4H) and 1.61 (s, 6H).

### vi) 1-(6{[2-(2,5-Dioxo-2,5-dihydro-1H-pyrrol-1-yl)ethyl]amino}-6-oxohexyl)-2-[(1E,3E)-3-(1-ethyl-3,3-dimethyl-5-sulpho-1,3-dihydro-2H-indol-2-ylidene)prop-1-enyl]-3,3-dimethyl-3H-indolium (Compound 1)

1-Ethyl-2,3,3-trimethyl-5-sulphonyl-indolium iodide (2.0 g, 7.48 mmol), N,N′-diphenylformamidine (1.5 g, 7.48 mmol) and triethylorthoformate (1.1 g, 7.48 mmol) were dissolved in ethanol (10 ml) then heated at reflux (100° C.) for 3 hours. A solid formed on the sides of the reaction flask and UV/VIS showed a new peak at 408 nm. Diethyl ether was added and the precipitate and the solid collected by filtration, washed with ether and-dried in vacuo to afford a yellow/orange solid (1.83 g, 66%). UV/VIS (MeOH); absorption λₘₐₓ=408 nm.

To a solution of the Cy3 half-dye (1.83 g, 6.22 mmol) in anhydrous pyridine (10 ml) was added acetic anhydride (1.0 ml) and the reaction stirred under a nitrogen atmosphere for 10 minutes. After this time 1-(5-carboxypentyl)-2,3,3-trimethyl indolium bromide (2.2 g, 6.22 mmol) was added and the reaction stirred at room temperature for 16 hours. The progress of the reaction was monitored by tic (20% MeOH/80% DCM). The solvent was removed under reduced pressure and purified using flash column chromatography (reversed phase silica: water-50% methanol gradient) to yield 299 mg of the desired Cy3 acid product (9%). UV/VIS (MeOH); absorption λₘₐₓ=550 nm.

Cy3 acid (50 mg, 0.09 mmol) was dissolved in anhydrous DMF under a nitrogen atmosphere then stirred at room temperature. DIPEA (16 μl, 0.09 mmol) and TSTU (30 mg, 0.09 mmol) were added and the reaction stirred for 2 hours until deemed complete to the NHS ester by tic (20% MeOH/80% DCM). Solvent was removed in vacuo and the residue was triturated with ether to yield a pink powder (40 g, 67%). δ_{H} (300 MHz, CDCl₃) 8.35 (m, 2H), 7.89 (m, 2H), 7.35-7.10 (m, 5H), 6.55 (m, 1H), 4.07 (m, 4H), 3.69 (m, 2H), 3.11 (m, 2H), 2.54 (m, 2H), 1.75-1.60 (m, 6H) and 1.42 (m, 15H). ESi+ MS 648.3. UV/VIS (MeOH); absorption λₘₐₓ=550 nm.

### vii) 1-(6-{[2-(2,5-Dioxo-2,5-dihydro-1H-pyrrol-1-yl)ethyl]amino}-6-oxohexyl)-3,3-dimethyl-2-[(1E,3E,5E)-5-(1,3,3-trimethyl-5-sulpho-1,3-dihydro-2H-indol-2-yldene)penta-1,3-dienyl]-3H-indolium (Compound II)

1,2,3,3-Tetramethyl-5-sulphonyl-indolium iodide (5.00 g, 11.90 mmol) was suspended in a mixture of acetic acid (40 ml) and TFA (2 ml, 18.0 mmol) until all of the solid dissolved. 1,3,3-Trimethoxypropene (12.5 ml, 95.0 mmol) was added to the reaction and stirred at room temperature for 5 hours. The solution was pipetted into 500 ml of diethyl ether and the precipitate collected by filtration (4.80 g, contains salts).

To a solution of the Cy5 half-dye (4.80 g, 14.9 mmol) in methanol (40 ml) was added potassium acetate (3.00 g, 34.2 mmol) and 1-(5-carboxypentyl)-2,3,3-trimethyl indolium bromide (3.00 g, 16.4 mmol). After stirring overnight, the solution was pipetted into diethyl ether (500 ml) and the blue solid collected by filtration and dried in vacuo. Purification was achieved by flash column chromatography (reversed phase silica: water-50% methanol gradient) to yield 2.30 g of desired product (28%).

Cy5 acid (50 mg, 0.09 mmol) was dissolved in anhydrous DMF under a nitrogen atmosphere then stirred at room temperature. DIPEA (16 μl, 0.09 mmol) and TSTU (30 mg, 0.09 mmol) were added and the reaction stirred for 2 hours until deemed complete to the NHS ester by tic (20% MeOH/80% DCM). Solvent was removed in vacuo and the residue was triturated with ether to yield a blue powder (65 g, 90%). δ_{H} (300 MHz, CD₃OD) 8.29 (m, 2H), 7.88 (m, 2H), 7.32-7.00 (m, 5H), 6.57 (t, J=13 Hz, 11H), 6.13 (m, 2H), 3.97 (m, 2H), 3.66-3.51 (m, 3H), 3.08 (m, 4H), 2.55 (m, 2H), 1.75 (m, 2H), 1.64 (m, 2H). and 1.35 (m, 12H). ESi+ MS 660.3. UV/VIS (MeOH); absorption λₘₐₓ=642 nm.

### Example 2

### 2.1 Cell Culture, Surface Protein Labelling and Protein Isolation

Initial experiments were performed on U937 cells (Human caucasian histiocytic lymphoma cells) supplied by ECACC (ECACC No. 85011440 CB No. CB2275). U937 cells were cultured according to suppliers recommended protocol. Cells were grown in RPMI-1640 growth medium (10% fetal calf serum), at 37° C., 5% CO₂ in an upright flask. Cells were counted and passaged every 2-3 days maintaining the cell concentration at 2-9×10⁵ cells/ml. The day prior to harvesting, cells were spun down and resuspended in fresh medium to minimise the levels of non-viable cells.

To maintain cell viability during labelling and to minimise CyDye hydrolysis, the cyanine dyes were reconstituted in PBS to give a final concentration of 80 μM immediately before use.

To minimise proteolysis, all buffers used were ice cold and all steps, where possible were carried out on ice; in addition, lysis buffers contained PSC-protector (Roche) and a protease inhibitor cocktail (Roche). Typically 1.5×10⁸ cells were used in each labelling reaction, with 5-10×10⁸ cells harvested per experiment. Cells were pelleted by centrifugation for 10 minutes at 4° C. at 12,000×g and washed in Dulbecco's formula PBS pH 7.2. The PBS was removed, cells resuspended in PBS (3-6 ml) and split into 1 ml fractions (1 per labelling experiment). For each 1 ml labelling reaction, cells were pelleted by centrifugation and the PBS removed. Cells were resuspended in 50 μl CyDye fluor in PBS (80 μM). For labelling, ˜45 pmoles of fluor was used per 50 μg total protein. Cell surface proteins were labelled by incubating the cell with fluor on ice for 15 minutes. The cells were pelleted by centrifugation to remove as much unreacted fluor as possible (to prevent labelling of inertial proteins). To quench any remaining unreacted fluor, the cells were resuspended in lysis buffer (7M urea, 2M thiourea, 4% w/v CHAPS, 30 mM Tris pH 7.5) containing 10 mM lysine. Cells were lysed by sonication (10 cycles at 6 μm amplitude for 20 s seconds with 1 minute cooling on ice water). The solution was centrifuged to pellet cell debris and the proteins (in the supernatant) retained.

The protein concentration of the U937 cell lysate was determined using the Bio-Rad Dc Protein Assay as described by the manufacturer (Bio-Rad, Hertfordshire, UK).

### 2.2 Total Protein Extraction and Labelling

For comparison of cell surface expressed proteins with total proteins, cell lysates were prepared. Following harvesting of U937 cells as described in Example 2, cells were resuspended in lysis buffer. Cells were lysed by sonication (10 cycles at 6 μm amplitude for 20 seconds with 1 minute cooling on ice water). The solution was centrifuged to pellet cell debris and the proteins (in the supernatant) labelled according to standard CyDye DIGE minimal labelling protocols (Ettan DIGE user manual, Amersham Biosciences, Buckinghamshire, UK).

### 2.3 Protein Separation by 2D Electrophoresis

2-D electrophoresis was performed using standard Amersham Biosciences 2D PAGE equipment and PlusOne™ reagents (Buckinghamshire, UK). Immobiline DryStrips (pH3-10 NL, 24 cm) were rehydrated overnight in 450 μl rehydration buffer (7M urea, 2M thiourea, 4% w/v CHAPS, 1% Pharmalytes (pH 3-10), 2 mg/ml DTT) overlaid with 2.5 ml DryStrip Cover Fluid, in an Immobiline DryStrip Reswelling Tray. Strips were focused using the IPGphor isoelectric focusing system. Prior to 2^{nd} dimension PAGE, each strip was equilibrated with 10 ml equilibration buffer A (7M urea, 2M thiourea, 100 mM Tris-HCl pH6.8, 30% v/v glycerol, 1% w/v SDS, 5 mg/ml DTT) on a rocking table for 10 minutes, followed by 10 ml equilibration buffer B (7M urea, 2M thiourea, 100 mM Tris-HCl pH6.8, 30% v/v glycerol, 1% w/v SDS, 45 mg/ml iodoacetamide) for a further 10 minutes. The strips were then loaded and run on 12.5% isochratic Laemmli SDS-PAGE gels.

### 2.4 Fluorescence Gel Imaging and Image Analysis

Labelled proteins were visualised using the Typhoon 9410 scanner (Amersham Biosciences, Buckinghamshire, UK) with the following settings:

| | Excitation | Emission |
|---|---|---|
| Cy3 | 540 nm (25 nmBP) | 590 nm (35 nmBP) |
| Cy5 | 620 nm (30 nmBP) | 680 nm (30 nmBP) |

Exposure times were optimised for individual experiments to give a maximum pixel value on the image of 99,000 to avoid saturation of the signal. For detailed quantitative analysis of dye matching, gel images were exported into DeCyder (Amersham Biosciences, Buckinghamshire, UK), a 2D differential analysis software programme.

### 2.5 Determination of Cell Membrane Permeability Using IN Cell™ Analyser

To determine the permeability of the cell membrane to different fluors, labelled cells were prepared as described in example 2.1 and intact cells analysed using the IN Cell analyser. This instrument is a confocal fluorescence microscope that can visualise cells at >0.5μm resolution and can be used to determine localisation of fluorescent labelling. To minimise proteolysis, all buffers used were ice cold and all steps, where possible were carried out on ice. For each fluor tested, cells were prepared and a labelling reaction was set up on ice (as described in example 2.1). At desired time points, duplicate aliquots of labelled cells were removed.

An aliquot of labelled cells was placed in a 384-well microtitre plate and read on the IN Cell Analyser. To check the viability of the cells, LIVE/DEAD viability stain (Molecular Probes) was added to the well and allowed to react for 10 minutes. Each well was read again on the IN Cell Analyser to determine those cells which were dead. Only those cells shown to be live were used to assess cell permeability as non-viable cells would be permeable to the dye.

An aliquot of labelled cells was washed to remove the unreacted free dye. The cells were washed with PBS and then the cells pelleted by centrifugation. The cells were resuspended in PBS and an aliquot placed in a microtitre plate and read on the IN Cell Analyser. To the remaining volume, LIVE/DEAD viability stain was added and the cells incubated for 10 minutes on ice. A further aliquot was placed in a microtitre plate and read on the IN Cell Analyser.

1. A method of detecting differences between surface membrane components from at least two samples containing closed membrane structures, said method comprising:
i) contacting a separate aliquot of each sample with a dye chosen from a matched set of dyes wherein each dye in said matched set is capable of selectively labelling said membrane components and wherein each dye emits luminescent light having a property that is distinguishably different from the emitted luminescent light of the remaining dyes in said matched set;
ii) preparing extracts of dye-labelled components from each separate aliquot;
iii) separating the different dye-labelled components; and
iv) detecting differences in a luminescence property between the different dye-labelled components in said samples;
wherein said separating step iii) is performed in the presence of an internal standard including an extract of membrane components from a pooled mixture of aliquots of said at least two samples and wherein said pooled mixture of samples containing membrane structures is contacted with a different dye chosen from said matched set of dyes.

2. The method of claim 1, wherein each separate aliquot of said samples is contacted with a different dye chosen from the matched set of dyes and wherein said method comprises before step iii), the step of mixing a portion of the extract of dye-labelled components from all samples with each other and with a portion of the extract of dye-labelled components from said pooled mixture before separating the components.

3. The method of claim 1, wherein each separate aliquot of said samples is contacted with the same dye chosen from the matched set of dyes and wherein said method comprises before step iii), the step of providing a portion of the extract of the dye-labelled components from said pooled extract mixed with a portion of the extract of dye-labelled components from each separate sample before separating the components.

4. The method of claim 1, wherein each of said dyes is matched one with the other by virtue of its charge and molecular weight characteristics.

5. The method of claim 1, wherein said matched set of dyes are selected from fluoresceins, rhodamines, cyanine dyes and acridone dyes.

6. The method of claim 1, wherein said matched set of dyes are selected from cyanine dyes having the structure: 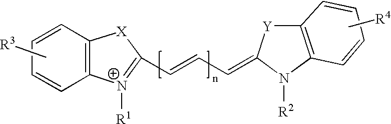
wherein:
n is an integer from 1 to 3;
X and Y are the same or different and are selected from: >C(CH₃)₂, O and S;
one of groups R¹ and R² is the group -E-F where E is a spacer group having a chain from 1-20 linked atoms selected from linear or branched C₁₋₂₀alkyl chains, which may optionally contain one or more ether linkages, one or more amide linkages, and one or more unsaturated groups, and F is a target bonding group capable of reacting with a complementary group on the component to be labelled;
remaining group R¹ or R² is selected from: C₁-C₆ alkyl, or the group —(CH₂)ₘ—W wherein W is selected from: 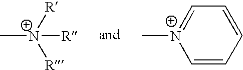
wherein R′, R″ and R′″ are selected from C₁-C₄ alkyl and m is an integer from 1 to 10;
at least one of groups R³ and R⁴is a sulphonate or a sulphonic acid group;
and when one of said R³ and R⁴ groups is not a sulphonate or a sulphonic acid group, said remaining group R³ or R⁴is a hydrogen.

7. The method of claim 1, wherein said matched set of dyes are selected from acridone dyes having the structure: 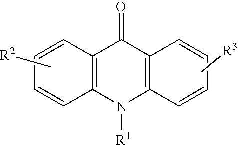
wherein:
one of groups R¹, R² and R³ is the group -E-F where E is a spacer group having a chain from 1-20 linked atoms selected from linear or branched C₁₋₂₀ alkyl chains, which may optionally contain one or more ether linkages, one or more amide linkages, and one or more unsaturated groups, and F is a target bonding group capable of reacting with a complementary group on the component to be labelled;
when either of groups R² or R³is not said group -E-F, they are independently selected from hydrogen, halogen, amide, hydroxyl, amino, mono- or di-C₁-C₄ alkyl-substituted amino, sulphydryl, carboxyl, C₁-C₆ alkoxy, C₁-C₆ alkyl, sulphonate, sulphonic acid, quaternary ammonium and the group —(CH₂—)ₙ-Z ; and,
when group R¹ is not said group -E-F, it is selected from hydrogen, C₁-C₆ alkyl, the group —(CH₂)ₖ-Z, wherein Z is selected from sulphonate, sulphonic acid, quaternary ammonium and carboxyl; and k is an integer from 1 to 6.

8. The method of claim 6, wherein each dye of said set has a target bonding group F which is a reactive group reactive with hydroxyl, amino, sulphydryl and aldehyde groups.

9. The method of claim 8 wherein said reactive group is selected from succinimidyl ester, sulpho-succinimidyl ester, isothiocyanate, maleimide, haloacetamide and hydrazide.

10. The method of claim 1, wherein said matched set of dyes are derivatives of dipyrromethine boron difluoride dyes.

11. The method of claim 1, wherein each of said dyes is distinguishable one from the other by virtue of its fluorescence wavelength and/or its fluorescence lifetime.

12. The method of claim 1, wherein said components comprise membrane proteins or fragments thereof:

13. The method of claim 12, wherein said proteins include phospho-proteins.

14. The method of claim 1, wherein said components comprise a carbohydrate derivative.

15. The method of claim 1, wherein said separation step is by an electrophoretic method.

16. The method of claim 15, wherein said electrophoretic method comprises one-dimensional electrophoresis, two-dimensional electrophoresis, capillary zone electrophoresis, capillary gel electrophoresis or isoelectric focussing.

17. The method of claim 1, wherein said separation step is by a chromatographic method.

18. The method of claim 17, wherein said chromatographic method comprises affinity chromatography, size exclusion chromatography, reverse phase chromatography, hydrophobic interaction chromatography, or ion exchange chromatography.

19. The method of claim 1, wherein the step of detecting differences in a luminescence property is by fluorescence microscopy.

20. The method of claim 1, wherein the step of detecting differences in a luminescence property is by optical imaging.

21. A matched pair of dyes wherein each said dye is capable of selectively labelling cell surface components and wherein each dye emits luminescent light having a property that is distinguishably different from the emitted luminescent light of the other dye and wherein each dye is selected from cyanine dyes having the structure (1): 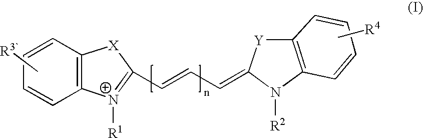
wherein:
n is an integer from 1 to 3;
X and Y are the same or different and are selected from: >C(CH₃)₂, O and S; one of groups R¹ and R² is the group -E-F where E is a spacer group having a chain from 1-20 linked atoms selected from linear or branched C₁₋₂₀ alkyl chains, which may optionally contain one or more ether linkages, one or more amide linkages, and one or more unsaturated groups; and F is a target bonding group capable of reacting with a complementary group on the component to be labelled;
remaining group R¹ or R² is selected from: C₁-C₆ alkyl, or the group —(CH₂)ₘ—W wherein W is selected from: 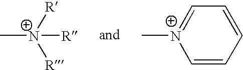
wherein R′, R″ and R′″. are selected from C₁-C₄ alkyl and m is an integer from 1 to 10;
at least one of groups R³ and R⁴ is a sulphonate or a sulphonic acid group;
and when one of said R³ and R⁴ groups is not a sulphonate or a sulphonic acid group, said remaining group R³ or R⁴ is a hydrogen.

22. The matched pair of dyes of claim 21, wherein each dye has characterisatics whereby relative migration in a separation medium of a component labelled with one of said dyes is the same as the relative migration in said separation medium of the component labelled with the other dye.

23. The matched pair of dyes of claim 21, wherein each dye has a target bonding group which is a reactive group reactive with hydroxyl, amino, sulphydryl and aldehyde groups.

24. The matched pair of dyes of claim 23, wherein each dye has a reactive group selected from succinimidyl ester, sulpho-succinimidyl ester, isothiocyanate, maleimide, haloacetamide and hydrazide.

25. The method of claim 7, wherein each dye of said set has a target bonding group F which is a reactive group reactive with hydroxyl, amino, sulphydryl and aldehyde groups.

26. The method of claim 25, wherein said reactive group is selected from succinimidyl ester, sulpho-succinimidyl ester, isothiocyanate, maleimide, haloacetamide and hydrazide.
